(19) United States
(12) Patent Application Publication
(10) Pub. No.: US 2007/0136171 A1
(43) Pub. Date: Jun. 14, 2007

(54) Method for picking securities

(75) Inventor: Marc Lepere, London (GB)

Correspondence Address: David A. Harlow;Nelson Mullins Riley & Scarborough, Meridian, Suite 1700, 1320 Main Street, Columbia, SC, 29201, US

(73) Assignee: VOX POP INVESTING LIMITED

(21) Appl. No.: 11/300,080

(22) Filed: Dec. 14, 2005

(51) Int. Cl. G06Q 40/00

(52) U.S. Cl. 705/36 R

(57) ABSTRACT

The invention is directed to a method, which may be used for selecting securities for purchase or sale. The method includes the use of customer polling. The customer polling may include questions, which are useful in determining customer perception as to which brands and companies are gaining, or falling, in popularity. The customers polled may be selected on the basis of certain attributes.

### TECHNICAL FIELD OF THE INVENTION

This invention relates generally to investing and more particularly to a method of selecting securities for purchase, or sale, in a portfolio.

### BACKGROUND OF THE INVENTION

There are many methods of selecting securities for purchase and investment. Daily, these methods are conducted formally and informally, by individuals, financial institutions, and other entities on a global basis. Many of the published methods commonly employed by the world's financial institutions are either self-referencing or sector based, and they operate from information that is quantitative and objective in combination with that which is qualitative and subjective. The sources of this information include macro economic factors, financial analytics, sector performance, individual company performance, interviews with company executives, expert market dynamics assessments, word-of-mouth and the “word-on-the-(Wall) Street.” More recently, there are some attempts to incorporate social and environmental trend data into stock selection decisions. However, these commonly employed methods can, for the most part, be described as remaining largely ‘self-referencing.’

For the majority of publicly listed securities traded either in the United States of America, or in other large financial centers around the world, a very high correlation exists between the value of a company and its market sales. In many cases, over the mid to long term, sales revenue is or becomes a key determinate of the company's earnings, and hence its value. The ultimate arbiter of value therefore, is often the end customer or purchaser of the company's products or services. For those companies selling business-to-business it likewise is the business customer.

### BRIEF SUMMARY OF INVENTION

The present invention is a method of selecting securities (such as stocks), for purchase which is at least partially based on measuring the perception of customers as to which brands or companies the customers perceive to be growing in popularity, and therefore are most likely to have future sales success, and ultimately increased stock value. The invention is based on the application of methodology used in both marketing and political science, and using it to significantly enhance the selection of stocks for investment purposes.

In one embodiment of the invention, the method includes (a) the selection of customers to be polled so as to enhance the percentage of polled customers to include a higher number of customers who will accurately predict and influence trends in the marketplace, (b) polling these selected customers to determine their perception of which brands and companies are gaining in popularity and which brands and companies are decreasing in popularity, (c) quantifying the perceptions of the polling results, and (d) applying the quantified poll results to the stock selection process.

### BRIEF DESCRIPTION OF THE DRAWINGS

FIG. 1 is a flowchart schematically illustrating the present invention in its general embodiment.

FIG. 2 is an illustration of a prototypical question structure for determining customer perceptions as to which brands are gaining in popularity over a time period.

FIG. 3 is a narrative illustration of a growth factor algorithm for quantifying the polling results.

### DETAILED DESCRIPTION OF THE INVENTION

The term “customer” means customer in its ordinary meaning, as well as any purchaser of goods or services whether for personal use or the use of a business, and any consumer or end user of goods or services.

The term “predictive customer” means a customer who is judged to represent the leading edge of mainstream customer behavior. Such customers are thought to be likely predictors of trends and/or to influence customer behavior.

The term “security” means a transferable financial interest in a commercial enterprise. A security may be based in equity, e.g. share of stock or debt, e.g. a bond, and may be memorialized in a legal instrument.

The term “stock” means stock in its ordinary meaning, as well as any security in an entity that is traded and is likely to represent value in the entity.

The term “rising stock” means products, brands, or companies that are gaining in popularity or sales, or are otherwise determined to ‘on the rise’.

The term “declining stock” means products, brands or companies that are losing in popularity or sales, or are otherwise determined to be on the decline.

The term “growth factor” means a factor calculated to be predictive of sales success in the marketplace.

The term “momentum polling” means polling that is designed to measure which individuals or entities are gaining ground relative to their competitors, either as perceived by the individuals polled, or in terms of preferences of the individuals polled.

The present invention enables individuals or entities selecting securities, such as stocks, for purchase to statistically quantify an extremely and, increasingly, important predictor of future stock prices which heretofore has not been capable of being quantified, and therefore underutilized in selecting stocks for portfolio purchases.

For ease of illustration, the focus hereinafter will be upon stock selection, but the reader should understand the present invention applies to other securities as well. While the underlying analytic and polling tools have been used in the past for market research and for predicting political election campaigns and results, they have not been applied to predicting future stock prices. The method of the present invention is enhanced by the use of computer automation to tabulate and analyze the data generated in the process of selecting customers to poll, in conducting the poll of the customers itself, and in analyzing the data collected in the poll and in organizing the data so that it is most useful to the individuals making the stock selections.

An investor's ability to select and purchase a stock before it starts to rise in value, sometimes referred to as the ability “to get in early,” is central to maximizing returns in investing in commercial enterprises. Conversely, the ability to select and sell a stock before its market value drops minimizes investment loses. The method of the present invention provides a useful tool to assist in predicting those stocks that are likely to rise or decline. The method of the present invention employs polling techniques with customers to identify brands of products and services, which are “rising” in the marketplace before the stock values of the companies producing them start to rise in the stock market. By using panel techniques, common to those practiced in market research, it is also possible to monitor the declining reputation or image of a given product, brand or company relative to its competitors or a particular issue. In this way, the present invention not only measures those stocks whose value is on the rise, indicating a “buy,” but also those stocks that are on the decline, indicating a “sell.”

In one embodiment of the invention, its early predictive capability is enhanced by identifying predictive customers and focusing either the polling or the polling results on such customers. Predictive customers exhibit the leading edge of mainstream consumer opinion and behavior. Therefore, their purchasing activity tends to predict future sales success of products and services, and ultimately foretells increases in stock value of the companies that provide those products and services.

Marketing professionals have long used data gathered from opinion leaders, influencers, avant-garde consumers, early adopters, gatekeepers, etc. as a means of both predicting trends, and influencing mainstream customer behavior. Surprisingly, while such data relating to the leading edge is routinely used in marketing practice, it has not been used as a tool in stock selection. Today's real-time, networked, media dominated, global commercial culture facilitates the identification of people who represent the leading edge of consumers and improves collection of data related to consumers' tastes and opinions, thus, is employed in the present invention.

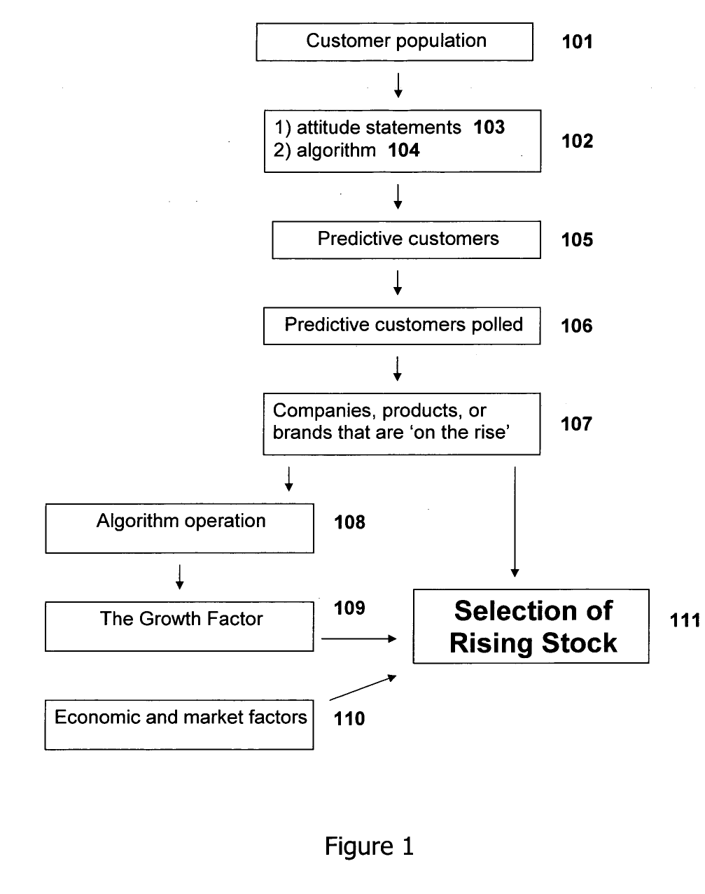

FIG. 1 schematically illustrates the present invention in one predictive customer embodiment. Referring to FIG. 1, groups from the customer population 101 are subjected to a battery of attitude statements and questions 103, and the data obtained analyzed by an algorithm 104 to identify a set of predictive customers 105. The set of predictive customers 105 is then subjected to polling 106. The results of the polling 106 are used to identify which products, brands or companies 107 that are gaining in popularity, i.e. “on the rise” with the set of predictive customers 105. The results of the polling 106 is then quantified by means of an algorithm 108 to determine a growth factor 109 which in turn is factored into the rising stock selection process 110 along with economic and market factors 111. If an investor wishes to select declining stocks, the investor would identify the products, brands, and companies 107 that are losing popularity with the set of predictive customers 105, and the growth factor 109 would be negative.

The predictive customer for companies selling direct to individuals is either an end consumer or a purchaser. The predictive customer for a company selling business-to-business is an individual in the business making, or involved in, the purchasing decision. This is particularly important given that most significant corporate buying decisions are now made by a committee or group. The predictive customers in both cases may be identified and selected from customers via a research questionnaire. Responses may be obtained face to face, on the telephone, online, or in any similar fashion that is statistically robust and representative. The responses of the questionnaire may be scored, rated, or otherwise quantified by whatever appropriate algorithm chosen.

The questionnaire presented to the customer might relate, inter alia, to the scope of their social networks, their degree of acceptance of new media reports, their adherence to tradition, their reliance on the opinion of their families and friends, and their general relationships to the commercial world. These statements in the questionnaire could be augmented and tailored in accordance with the desired data. In scoring the responses of the customers, one might label “strongly agree” and “somewhat agree” as the “top two boxes.” Likewise “strongly disagree” and “somewhat disagree” as the “bottom two boxes.” Using this terminology, an algorithm might then be constructed to find predictive customers as those whose responses correspond to a predetermined pattern.

An example of a questionnaire to determine predictive customers might be a series of attitude statements where the customers are asked to rate themselves on a five point scale where 5=agree strongly, 4=somewhat agree, 3=neither agree nor disagree, 2=somewhat disagree, and 1=strongly disagree. An example of the attitude statements to be self evaluated in the example, and responses tending to indicate predictive customers, might be the following:
1. I consider myself to be a traditionalist with little interest in modern culture and society. [Bottom 2 boxes]
2. I have a wide social network and make a point of being in regular (daily, weekly) contact with my friends and family/or colleagues. [Top 2 boxes]
3. I always accept at face value what I read in newspapers and magazines and what I hear on television and radio. [Neutral or bottom 2 boxes]
4. I regard myself as someone who always likes to make up, and know, my own mind. [Top 2 boxes]
5. I'm usually one of the first people I know to try new things. [Top 2 boxes]
6. I consider each purchase in its own right, my concept of value is not necessarily about low price. [Top 2 boxes]
7. I often tell other people when I have a particularly bad, or good, experience with a company, product, brand, venue, vendor, etc. [Top 2 boxes]
8. I am often consulted by my friends or family/colleagues for advice on holidays, purchases, restaurants, movies, etc. [Top 2 boxes]
9. I feel overloaded and excluded by the commercial world. [Bottom 2 boxes]
10. Recommendations from family and friends/or colleagues influence my product and service choices more than advertising or other commercial messages. [Top 2 box]

For a discussion of an advanced, opinion leading consumer, similar in concept to “predictive customers,” see “The Tipping Point” by Malcolm Gladwell published by Little, Brown and Company (2000).

In a series of benchmark tests conducted in various countries around the world, it has been determined that the predictive customer as defined above often represents on the order of 15% or 20% of the population, depending on the country. It is therefore preferred to conduct a sufficient number of random interviews among a representative sample of the total population, with a standard deviation of +/−5% to ensure that the required proportion of predictive customers is sampled. This is a standard market survey practice well known to those in the industry to ensure a statistically robust sample and survey. For example, see “Inside the Minds”—Succeeding as a Marketing Executive published by Aspatore Inc. (2005).

After a set of predictive customers has been selected (as described above), those customers are subjected to momentum polling to determine which brands, products and companies are gaining in popularity. Momentum polling as a base concept is a standard methodology in political science. For example, in political science the base methodology may be used to establish whether, in an individual's opinion, a particular candidate or party is perceived by that individual to be gaining ground, losing ground, staying the same among the electorate on a particular issue, or versus his or her opponent as election nears. In this adaptation, it is not a measure of individual opinion, but rather a measure of perceived popularity among the electorate as a whole, albeit in the opinion of an individual. This base methodology may be easily adapted by those skilled in the art of polling to gauge the public's perception of which products, brands or companies are gaining in popularity. In an embodiment of the invention, the selection of predictive customers, as described above, either before, during or after the polling process, will significantly increase the efficiency and reliability of the polling results.

The term rising stock may be used to refer to either the perceived growth, or momentum, in reputation and sales of a given product, brand or company relative to its competitors or a particular issue. It may be obtained in one embodiment of the present invention by tabulating the responses to the polling of the predictive customer set to questions which in their most general form may be expressed as a base rising stock question:
In terms of popularity among consumers, which of the following products/brands/companies has gained ground, lost ground or stayed the same over the past 6 to 12 months?

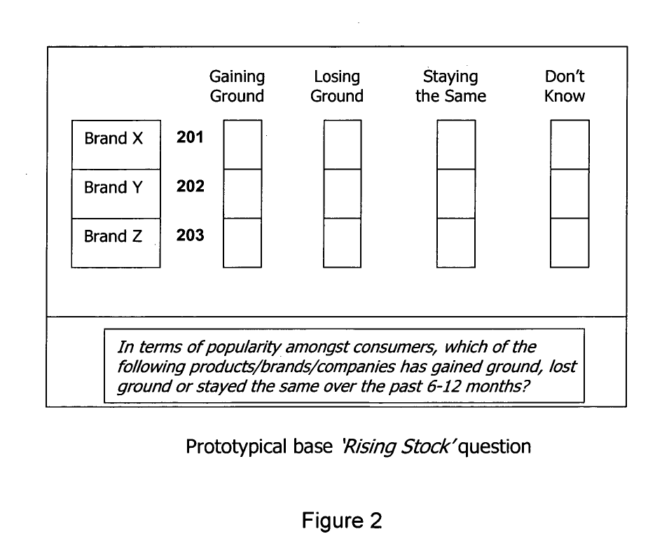

The base rising stock question as stated above measures perceived popularity rather than market share, i.e. a ranking of products, brands and companies relative to a given set, and the core idea of gaining, losing or being static. In one embodiment, the respondents should also be offered a “don't know” option. The latter response can thus account for those products, brands and companies that have insufficient activity to generate an opinion. A prototypical rising stock question measuring Brands X, Y and Z, and incorporating a “don't know” response is illustrated in FIG. 2.

In FIG. 2, Brand X 201 is measured against Brand Y 202 and Brand Z 203 in the polled customers perception as to popularity over the past 6 to 12 months with questions directed to each brand as to whether said brand is gaining ground, losing ground, staying the same, or the polled customer “doesn't know”.

From the question illustrated in FIG. 2, one skilled in the art of constructing polling questions might construct more complex question sets that would include measuring brands both within market sectors such as technology or automobiles, or across market sectors. Likewise, it is possible to measure products, brands and companies relative to particular issues, which may be important to customers within particular industry segments. For instance, food brands could be compared on the issue of trust, electronics brands on the basis of style, technology brands on the basis of reliability, and medical brands on perceived efficacy. In particular, when polling questions of this type are submitted to predictive customers, their experiences and predictions as measured in their responses regarding which products, brands and companies are growing in popularity and sales among the mass market, will assist in predicting which stock prices are likely to increase.

Over the last fifteen years or so, the economies of industrialized nations have become increasingly real time, networked, media influenced, global and commercialized. These factors have only increased the strength and influence of the customer on commercial success, and this growing importance of the buying decisions of customers in the marketplace is a foundation of the methodology of this invention.

The financial markets are made, as much as anything, by media news reports, informal news, often referred to as “market buzz” or “the word-on-the-(Wall) Street,” and plain rumor. In today's ever-present and instantaneously information rich world, this is increasingly the case. It is compounded by the democracy of investing. That is, the market is no longer restricted to the professionals or the extremely wealthy, but is instead actively played by hundreds of millions of private investors all over the world. In this context, the predictive customer is not only increasingly influential in deciding what products and services succeed or fail, and helping us identify their rise and fall, but is now also directly influential in stock trading momentum. It is well documented that the typical customer will tell of a good or bad experience to an average of 7 people.

Although review of the qualitative results of the polling as described above, provided useful insight into market and stock trends, tabulation and quantification of the results by application of one or more algorithms enhance their usefulness. Further, such tabulation and quantification promote a fair comparison of like factors in what is essentially a comparison process.

One such quantification can be achieved by a calculation that can be labeled the determination of the “growth factor”. In such a case, the concept is to determine the strength of momentum or energy behind a product, brand or company. In effect, one is seeking to measure the growing reputation and growing in-market sales. It is an early measure of de facto sales growth and forward momentum among the predictive customers who are the most likely to try new things and pass on recommendations to friends, family or colleagues. While the typical customer will tell of his or her experience to an average of 7 people, the predictive customer is estimated to tell an average of 35 people, thus increasing their value to stock-pickers.

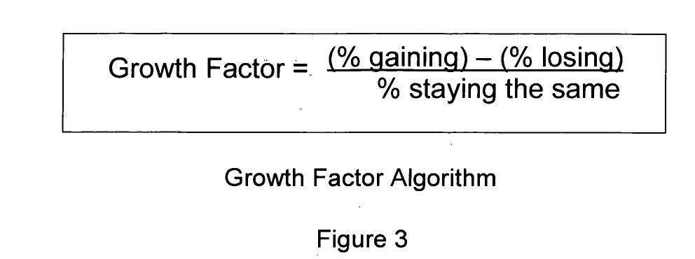

A growth factor may, for example, be calculated by scoring the tabulated responses to the polling question illustrated in FIG. 2, according to the growth factor algorithm illustrated in FIG. 3, that is:

$$Growth Factor = \frac{( \% gaining ) - ( \% losing )}{\% staying the same}$$

Other algorithms that achieve substantially the result as the algorithm described above are within the scope of the present invention. That is, the concept of applying an algorithm to quantify according to the preferences and objectives of the individual constructing the analysis may be done, while still using the concept of a quantification of the results. In the above example, and as illustrated in FIG. 3, in the preferred embodiment the percentage of “don't know” is discounted because it accounts for those products, brands and companies that have insufficient current activity in the marketplace to generate an opinion from some of the predictive customers who are likely the most active and interested customers.

Use of an algorithm such as the growth factor is a fundamental difference between the method of the present invention and traditional stock-picking methods. The present invention utilizes the theory that the ultimate arbiter of stock value is the marketplace for a company's products, and the strength of the company's brands or reputation in that marketplace. The present invention is focused not on reporting current sales or share of products and brands, but on trends and predicted future sales of the products and brands.

The present invention is unique in combining methodology from both marketing and political science and applying it to stock picking for investment purposes. To the extent anyone in the past has used consumer based information in picking stocks, it has been subjective judgment, rather than scientific polling or any other scientific or quantifiable analysis.

The ultimate arbiter of stock value, the customer, unlike financial institutions, often doesn't know, or care, who the parent or quoted company of their purchase is. Products, brands and/or companies therefore need to be allocated to their respective listed companies. Listed companies with products, brands and/or companies that have a higher scoring are more likely to experience higher rises in value and hence yield higher investment returns. The earlier in the rising cycle of sales that this can be detected, the greater the advantage to the investor.

The methodology of the present invention can be applied to any category, sector, or product brand, or company selling in the business to consumer, or business to business market. While the techniques used herein may be used to make investment decisions, other factors or analysis can be used in combination with or independent of these techniques to make investment decisions for a particular portfolio without departing from the scope of the invention.

Although the present invention has been described in detail, it should be understood that various changes, substitutions and alterations can be made hereto without departing from the sphere and scope of the invention as defined by the appended claims.

To aid the patent office, and any readers of any patent issued on this application in interpreting the claims appended hereto, applicants wish to note that they do not intend any of the appended claims to invoke paragraph 6 of 35 U.S.C. §112 as it exists on the date of filing hereof unless “means for” or “step for” are used in the particular claim.

What is claimed is:

1. A method for selecting securities, comprising:
polling customers to determine which products, brands or companies said customers perceive to be growing or declining in popularity; and
based upon the results of the customer poll, selecting securities for purchase or sale.

2. The method of claim 1, further comprising:
a pre-polling selection of customers for polling which is calculated to increase the efficiency or validity of the information obtained in the polling of customers.

3. The method of claim 1, further comprising:
concurrently with the polling of customers, also polling the customers as to certain attributes; and
factoring the customer attributes into the analysis of the customer polling results.

4. The method of claim 1, further comprising:
subsequent to the polling of customers, polling the customers as to certain attributes; and
factoring the customer attributes into the analysis of the customer polling results.

5. The method of claim 1, wherein the polling of customers includes at least one question directed to which products, brands or companies are gaining in popularity.

6. The method of claim 1, wherein the polling of customers includes at least one question directed to which products, brands or companies are declining in popularity.

7. The method of claim 2, wherein the pre-polling selection of customers is calculated to determine which customers are most likely to be predictive of future trends in purchasing.

8. The method of claim 3, wherein the polling of customers as to certain attributes is calculated to determine which customers are most likely to be predictive of future trends in purchasing.

9. The method of claim 4, wherein the polling of customers as to certain attributes is calculated to determine which customers are most likely to be predictive of future trends in purchasing.

10. A method for selecting securities, comprising:
selecting securities for purchase or sale based on the results of customer polling directed to customer perception of which products, brands or companies are growing or declining in popularity.

11. The method of claim 1, further comprising:
quantifying the results of the polling of customers in order to determine which products, brands or companies are likely to enjoy the greatest future growth in sales.

12. The method of claim 1, wherein the polling of customers contains questions as to which products, brands or companies are gaining ground in the marketplace, and which are staying the same.

13. The method of claim 10, wherein quantifying the results of the polling includes determining the projected growth in market popularity or sales of a product, brand or company by the formula:
Growth=percentage of customers responding the brand (or product or company) will gain popularity or sales, minus the percentage of customers responding the brand (or product or company) will lose popularity or sales, divided by the percentage of customers responding that sales or popularity will remain the same.

14. The method of claim 10, wherein quantifying the results of the polling includes determining the projected growth in market popularity or sales of a product, brand or company by the formula:
Growth=percentage of customers responding the brand (or product or company) will gain popularity or sales, minus the percentage of customers responding the brand (or product or company) will lose popularity or sales.

15. A method, comprising:
polling customers to determine which products, brands or companies they perceive to be growing in popularity for the purpose of selecting securities for purchase or sale.

16. A method, comprising:
Purchasing securities based on the results of customer polling directed to customer perception of which products, brands or companies are growing in popularity.

17. A method of selecting securities comprising:
(a) selection of customers to be polled so as to enhance the percentage of polled customers to include a higher number of customers who will accurately predict trends in marketplace.
(b) polling these selected customers to determine their perception of which products, brands or companies are gaining in popularity and which products, brands or companies are declining in popularity.
(c) quantifying the perceptions of the polling results, and
(d) applying the quantified poll results to the securities selection process.
